(19) United States
(12) Patent Application Publication
(10) Pub. No.: US 2024/0092361 A1
(43) Pub. Date: Mar. 21, 2024

(54) ELECTRONIC DEVICE, VEHICLE, AND STORAGE MEDIUM

(71) Applicant: ISUZU MOTORS LIMITED, Tokyo (JP)

(72) Inventors: Takashi KAWANO, Fujisawa-shi (JP); Ai TAKEDA, Fujisawa-shi (JP); Masahiro SEKI, Fujisawa-shi (JP)

(21) Appl. No.: 18/465,196

(22) Filed: Sep. 12, 2023

(30) Foreign Application Priority Data
Sep. 21, 2022 (JP) 2022-149911

(51) Int. Cl. B60W 30/14; B60W 50/14

(52) U.S. Cl. CPC B60W 30/146; B60W 50/14; B60W 2050/146; B60W 2530/10; B60W 2555/60

(57) ABSTRACT

An electronic device includes a storage that stores the gross weight of the vehicle V, an identification part that identifies a plurality of speed limits on a road on which the vehicle V is traveling, and an output part that outputs a first speed limit among the plurality of speed limits as an applied speed limit when the gross weight stored in the storage is equal to or greater than a threshold, and output a second speed limit which is higher than the first speed limit among the plurality of speed limits as the applied speed limit when the gross weight is not equal to or greater than the threshold.

### CROSS-REFERENCE TO RELATED APPLICATIONS

The present application claims priority to Japanese Patent Applications number 2022-149911, filed on Sep. 21, 2022, contents of which are incorporated herein by reference in their entirety.

### BACKGROUND OF THE INVENTION

The present disclosure relates to an electronic device for identifying a speed limit of a road on which a vehicle travels, a vehicle including the electronic device, and a storage medium.

Some road signs include a main sign that indicates a speed limit and an auxiliary sign that indicates a class of vehicle to which the speed limit indicated on the main sign applies. Japanese Unexamined Patent Application Publication No. 2018-116553 discloses a technology for determining whether a vehicle is the class of vehicle subject to the main sign, on the basis of a result of estimating a word that is present in a portion of an auxiliary sign by analyzing images of the main sign and the auxiliary sign.

### Problem to be Solved by the Invention

In order to recognize a content of the auxiliary sign, it requires a highly accurate character recognition process in the conventional technology. If characters are erroneously recognized in the character recognition process, there is a problem that a speed limit cannot be correctly recognized.

### BRIEF SUMMARY OF THE INVENTION

The present disclosure focuses on this point, and its object is to improve accuracy of recognizing a speed limit of a road on which a vehicle is traveling.

An electronic device according to a first aspect of the present disclosure includes a storage that stores a gross weight of a vehicle; an identification part that identifies a plurality of speed limits of a road on which the vehicle is traveling; and an output part that outputs a first speed limit among the plurality of speed limits as an applied speed limit when the gross weight stored in the storage is equal to or greater than a threshold, and outputs a second speed limit that is higher than the first speed limit among the plurality of speed limits as the applied speed limit when the gross weight is not equal to or greater than the threshold.

An electronic device according to a second aspect of the present disclosure includes: a storage that stores a passenger capacity of a vehicle; an identification part that identifies a plurality of speed limits on a road on which the vehicle is traveling; and an output part that outputs a first speed limit among the plurality of speed limits as an applied speed limit when the passenger capacity stored in the storage is equal to or greater than a threshold, and outputs a second speed limit which is higher than the first speed limit among the plurality of speed limits as the applied speed limit when the passenger capacity is not equal to or greater than the threshold.

A vehicle according to a third aspect of the present disclosure includes the above mentioned electronic devices.

A non-transitory storage medium according to a fourth aspect of the present disclosure stores a program that causes a computer to function as: an identification part that identifies a plurality of speed limits on a road on which the vehicle is traveling; and an output part that outputs a first speed limit among the plurality of speed limits as an applied speed limit when a gross weight stored in a storage is equal to or greater than a threshold, and outputs a second speed limit that is higher than the first speed limit among the plurality of speed limits as the applied speed limit when the gross weight is not equal to or greater than the threshold.

### BRIEF DESCRIPTION OF THE DRAWINGS

FIG. 1 shows an outline of a vehicle V.

FIG. 2A shows an example of a plurality of signs S designating different speed limits depending on the classes of the vehicles V.

FIG. 2B shows an example of a plurality of signs S designating different speed limits depending on the classes of the vehicles V.

FIG. 3 shows a configuration of the vehicle V.

FIG. 4 shows an example of a relationship between a speed limit and code information.

FIG. 5 is a flowchart showing a flow of processing in an electronic device 1.

FIG. 6 shows a configuration of a vehicle V according to Variation Example 1.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of a Vehicle V]

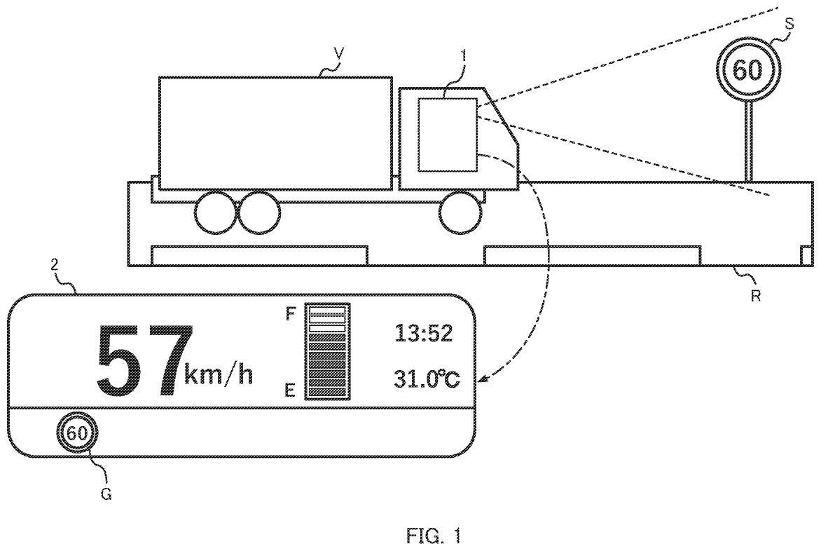

FIG. 1 shows an outline of a vehicle V according to the present embodiment. The vehicle V recognizes a speed limit of a road R on which the vehicle V is located. Further, the vehicle V has a function of displaying the speed limit of the road R on a display 2 that displays a speed, fuel level, time, temperature, or the like. In the example shown in FIG. 1, an icon image G indicating that the speed limit is 60 km/h is displayed. The display 2 is provided on an instrument panel of the vehicle V, and it may be provided on an information terminal used by a driver, for example.

The vehicle V includes an electronic device 1 that executes a process of displaying a speed limit on the display 2. The electronic device 1 may be in any form. The electronic device 1 may have a housing including electronic components, or may be a printed circuit board on which the electronic components are mounted.

The electronic device 1 identifies the speed limit on the basis of captured image data of a sign S captured by an imaging device, for example. The electronic device 1 causes the display 2 to display the speed limit by outputting information indicating the identified speed limit to the display 2.

There are cases where different speed limits are designated on the road R depending on the classes of the vehicles V. Specifically, there are cases where a plurality of signs S corresponding to the classes of the vehicles V may be installed at approximately the same position. In this case, the plurality of signs S are provided with auxiliary signs describing the classes of the vehicles subject to the designated speed limits.

The classes of the vehicles V correspond to the gross vehicle weight, passenger capacity, whether towing or not, or the like, for example. As an example, when the gross vehicle weight of the vehicle V is 11 tons or more, the class of the vehicle V is a heavy-duty vehicle, and when the gross vehicle weight of the vehicle V is less than 11 tons, the class of the vehicle V is a non-heavy-duty vehicle. The gross vehicle weight is a weight obtained by adding the weight equivalent of the maximum number of passengers and the maximum carried load to a vehicle weight. In the following description, “the gross vehicle weight” is referred to as “the gross weight”.

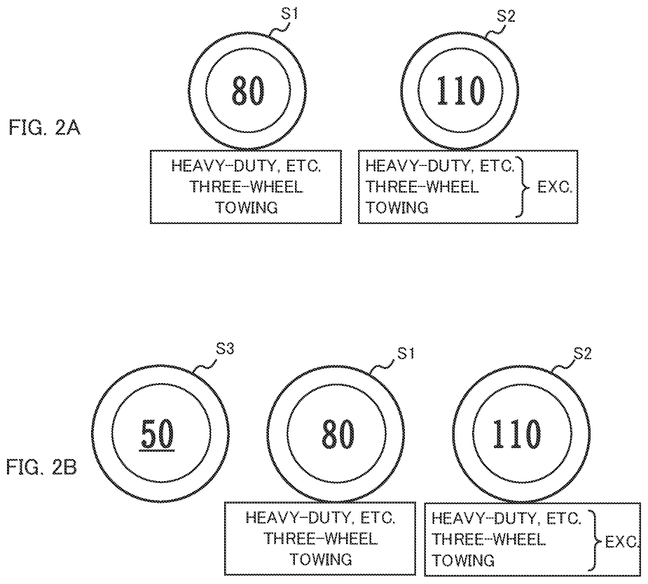

FIGS. 2A and 2B each show an example of a plurality of signs S designating different speed limits depending on the classes of the vehicles V. A sign S1 shown in FIG. 2A is provided with an auxiliary sign indicating that the speed limit of a heavy-duty vehicle, a three-wheel vehicle, and a towing-vehicle is 80 km/h. Further, a sign S2 is provided with an auxiliary sign indicating that the speed limit of a vehicle other than a heavy-duty vehicle, a three-wheel vehicle, and a towing-vehicle is 110 km/h. Three signs shown in FIG. 2B include, in addition to the two signs shown in FIG. 2A, a sign S3 indicating that the minimum speed limit is 50 km/h.

Since the characters inscribed on the auxiliary sign are small, it is not easy for the vehicle V to recognize a content of the auxiliary sign on the basis of an image captured by the imaging device when the plurality of signs S are installed in the above-described manner. In addition, there may be a case where the characters inscribed on the auxiliary sign become faint and disappear earlier than the number indicating the speed limit, due to deterioration over time of the sign, or a case where the auxiliary sign cannot be easily read since it has become dirty. Therefore, the vehicle V according to the present embodiment is characterized by determining whether to follow a speed limit corresponding to the sign S having a relatively high speed limit or a speed limit corresponding to the sign S having a relatively low speed limit among the plurality of signs S, depending on the class of the vehicle V such as the gross weight, the passenger capacity, or the like of the vehicle V.

Since the vehicle V is configured in this manner, even when the vehicle V does not have a high-performance character recognition function, it is possible to notify a driver about the speed limit corresponding to the vehicle V or to automatically control the vehicle V to travel at the speed limit corresponding to the vehicle V. Hereinafter, the configuration and operation of the vehicle V will be described in detail.

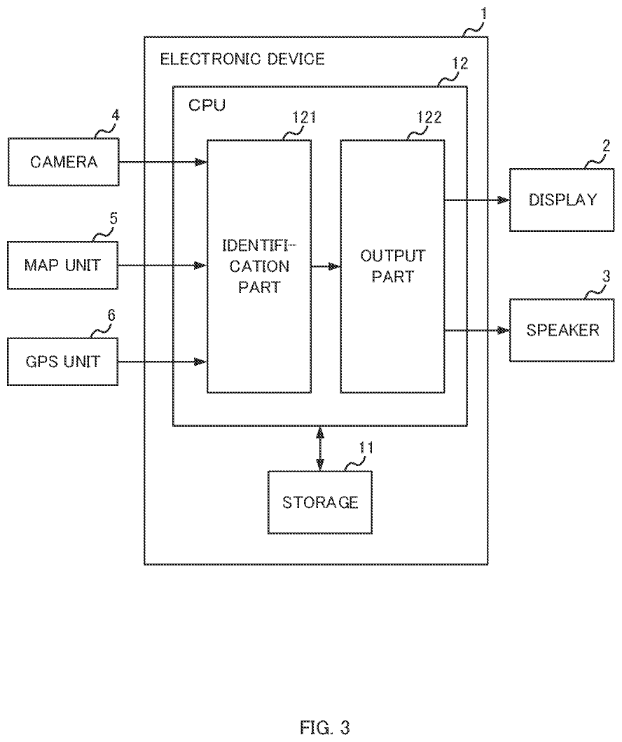

FIG. 3 shows the configuration of the vehicle V. The vehicle V includes an electronic device 1, a display 2, a speaker 3, a camera 4, a map unit 5, and a GPS unit 6. The electronic device 1 includes a storage 11 and a central processing unit (CPU) 12. The CPU 12 includes an identification part 121 and an output part 122.

The display 2 functions as a display apparatus for displaying various types of information as described above. The speaker 3 functions as a sound generation apparatus that generates sound. The speaker 3 emits the sound so as to be heard by the driver. The speaker 3 outputs an audio warning or emits voice indicating a speed limit, for example.

The camera 4 generates captured image data by capturing a view in front of the vehicle V. The camera 4 provides the generated captured image data to the identification part 121.

The map unit 5 transmits and receives data to and from an external server via a communication network. The map unit 5 receives map data from an external server that provides the map data, and stores the received map data. When the map unit 5 receives a notification that the map data has been updated from the external server, the map unit 5 acquires the updated map data. In response to a request from the identification part 121, the map unit 5 provides the identification part 121 with map data around a location where the vehicle V is traveling. The map unit 5 may be equipped with storage medium storing the map data and need not receive the map data from the external server.

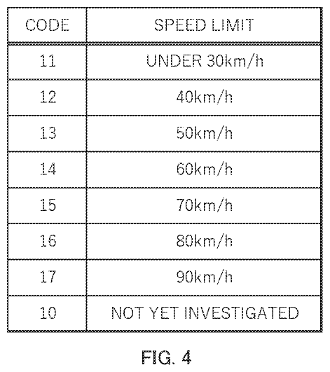

The map data includes data indicating a speed limit in association with the latitude and longitude. The speed limit is represented by code information, and the latitude and longitude are associated with the code information in the map data. FIG. 4 shows an example of a relationship between the speed limit and the code information.

The GPS unit 6 receives radio waves transmitted from GPS satellites, and calculates the latitude and longitude on the basis of information included in the received radio waves. The GPS unit 6 provides the calculated latitude and longitude to the identification part 121 as position information of the vehicle V.

The storage 11 includes a storage medium such as a read only memory (ROM), a random access memory (RAM), a solid state drive (SSD), and the like. The storage 11 stores a program executed by the CPU 12.

Further, the storage 11 stores various types of data which the CPU 12 uses to execute processing of displaying the speed limit on the display 2. The storage 11 stores a plurality of pieces of sample image data corresponding to each of a plurality of speed limits, which are used for the CPU 12 to recognize the speed limits inscribed on the signs, for example.

The storage 11 further stores information related to the classes corresponding to the size of the vehicle V, such as the gross weight, the maximum carried load, or the passenger capacity of the vehicle V. Further, the storage 11 stores a threshold used for the output part 122 to determine which speed limit sign among a plurality of speed limit signs corresponds to the vehicle V. The storage 11 may store a speed limit data table in which the code information and speed limit shown in FIG. 4 are associated with each other.

The identification part 121 identifies a plurality of speed limits on the road on which the vehicle V is traveling. The identification part 121 identifies the speed limit of the road on which the vehicle V travels by recognizing the speed limit sign on the basis of the captured image data generated by the camera 4 while the vehicle V is traveling, for example. For example, in the captured image data, the identification part 121 searches for a region whose similarity with the sample image data stored in advance in the storage 11 is equal to or greater than a threshold and identifies a speed limit corresponding to the sample image data similar to the image data of the detected region. The identification part 121 may identify the speed limit by searching for a region having characteristics of an image of the speed limit sign and performing a character recognition process on the detected region of the speed limit sign. The identification part 121 inputs information indicating the identified speed limit to the output part 122.

When having recognized the plurality of speed limit signs in the captured image data, the identification part 121 identifies a numerical value inscribed on each of the plurality of speed limit signs as the plurality of speed limits. In this case, the identification part 121 inputs a plurality of pieces of information indicating the plurality of speed limits to the output part 122. In a case where the number indicating the speed limit is underlined, the identification part 121 may input text information indicating the minimum speed limit together with information indicating the minimum speed limit to the output part 122.

The output part 122 outputs information corresponding to text or an image to be displayed on the display 2 to the display 2. The output part 122 may output information corresponding to sound to be emitted from the speaker 3 to the speaker 3. Specifically, the output part 122 outputs the speed limit input from the identification part 121 to at least one of the display 2 or the speaker 3 as an applied speed limit. The applied speed limit is the speed limit to be displayed on the display 2 or the speed limit to be emitted by voice from the speaker 3. The output part 122 outputs information indicating the applied speed limit to the display apparatus of the vehicle V, thereby displaying the applied speed limit on the display apparatus.

When the plurality of pieces of information corresponding to the plurality of speed limits are input from the identification part 121, the output part 122 selects a speed limit corresponding to any one piece of information. The output part 122 outputs a result of determining whether to follow the speed limit corresponding to the sign S having the relatively high speed limit or the speed limit corresponding to the sign S having the relatively low speed limit among the plurality of signs S, depending on the classes of the vehicle V such as the gross weight, the passenger capacity, or the like of the vehicle V. Specifically, when the gross weight of the vehicle V stored in the storage 11 is equal to or greater than a weight threshold, the output part 122 outputs a first speed limit among the plurality of speed limits as the applied speed limit. When the gross weight is less than the weight threshold, the output part 122 outputs a second speed limit that is higher than the first speed limit among the plurality of speed limits as the applied speed limit. The weight threshold is the minimum value of the gross weight of a vehicle that is considered as a heavy-duty vehicle, and is 11 tons, for example.

The first speed limit is the lowest speed limit among the plurality of speed limits corresponding to the plurality of signs, for example. In the example shown in FIG. 2A, when the gross weight of the vehicle V is equal to or greater than the weight threshold, the output part 122 determines that the sign S1 having the lower speed limit among the signs S1 and S2 is the sign that corresponds to the vehicle V, and outputs 80 km/h as the applied speed limit, for example. On the other hand, when the gross weight of the vehicle V is less than the weight threshold, the output part 122 determines that the sign S2 having the higher speed limit among the signs S1 and S2 is the sign that corresponds to the vehicle V, and outputs 110 km/h as the applied speed limit, for example.

If the plurality of speed limits corresponding to the plurality of signs include the minimum speed limit of the road on which the vehicle V is traveling, the first speed limit is the lowest speed limit among the speed limits excluding the minimum speed limit, for example. Further, if the plurality of speed limits corresponding to the plurality of signs include the minimum speed limit of the road on which the vehicle V is traveling, the second speed limit is the highest speed limit among the plurality of speed limits excluding the minimum speed limit, for example. The minimum speed limit is the slowest speed allowed when the vehicle V travels on a highway, and the vehicle V must travel at a speed equal to or faster than the minimum speed limit, for example.

In the example shown in FIG. 2B, when the gross weight of the vehicle V is equal to or greater than the weight threshold, the output part 122 determines that the sign S1 corresponding to the lowest speed limit among the signs S1 and S2, excluding the sign S3 corresponding to the minimum speed limit of 50 km/h, is the sign that corresponds to the vehicle V, and outputs 80 km/h as the applied speed limit, for example. On the other hand, when the gross weight of the vehicle V is less than the weight threshold, the output part 122 determines that the sign S2 corresponding to the highest speed limit among the signs S1 and S2 excluding the sign S3, is the sign that corresponds to the vehicle V, and outputs 110 km/h as the applied speed limit, for example.

When the gross weight of the vehicle V is less than the weight threshold and there are three or more signs excluding the sign corresponding to the minimum speed limit, the output part 122 may output the second lowest speed limit among the speed limits corresponding to the plurality of signs excluding the sign corresponding to the minimum speed limit, instead of the highest speed limit. Since the output part 122 operates in this manner, it is possible to prevent outputting a speed higher than the speed limit corresponding to the vehicle V as the applied speed limit.

Further, when there are a plurality of weight thresholds, the output part 122 may output the applied speed limit corresponding to the vehicle V on the basis of the plurality of weight thresholds. Specifically, in a case where the storage 11 stores a first weight threshold and a second weight threshold smaller than the first weight threshold and there are three signs excluding the sign corresponding to the minimum speed limit, the output part 122 outputs the lowest speed limit among three speed limits corresponding to the three signs as the applied speed limit when the gross weight of the vehicle V is equal to or greater than the first weight threshold. When the gross weight of the vehicle V is equal to or greater than the second weight threshold and less than the first weight threshold, the output part 122 outputs the second lowest speed limit among the three speed limits as the applied speed limit. When the gross weight of the vehicle V is less than the second weight threshold, the output part 122 outputs the highest speed limit among the three speed limits as the applied speed limit.

By referencing data stored in the storage 11 and in which (i) a weight range defined by the plurality of weight thresholds is associated with (ii) one or more signs among the plurality of signs, the output part 122 may output a speed limit indicated by the sign corresponding to the weight range which the weight of the vehicle V belongs to, as the applied speed limit. Since the output part 122 operates in this manner, even if the number of predetermined weight thresholds does not match the number of signs identified by the identification part 121, the output part 122 can output a speed limit indicated by the sign corresponding to the weight of the vehicle V as the applied speed limit.

In a case where the speed limit corresponding to one sign selected from among the plurality of signs is output as the applied speed limit, the output part 122 may output sound data so as to emit predetermined sound to the speaker 3. By having the speaker 3 emit the sound, the driver can grasp that the speed limit indicated by one sign among the plurality of signs is displayed, and therefore the driver can visually confirm whether the selected sign is appropriate.

### [Flow of Processing in the Electronic Device 1]

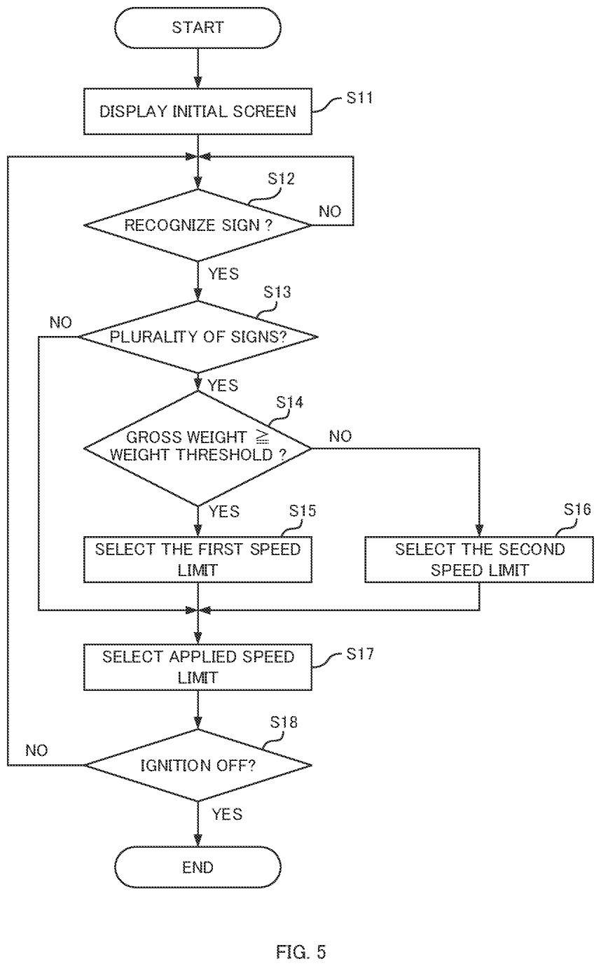

FIG. 5 is a flowchart showing a flow of processing in the electronic device 1. The flowchart shown in FIG. 5 starts when the power of the vehicle V is turned on (ignition on).

The output part 122 outputs information for displaying an initial screen to the display 2, and causes the display 2 to display the initial screen (S11). In the initial screen, no speed limit is displayed.

Next, the identification part 121 starts recognition of a sign (S12). Upon recognizing a speed limit sign (YES in S12), the identification part 121 determines whether a plurality of speed limit signs are installed (S13). When it is determined that a plurality of speed limit signs are not installed (NO in S13), the identification part 121 notifies the output part 122 about the speed limit indicated by the recognized sign. When it is determined that a plurality of speed limit signs are installed (YES in S13), the identification part 121 notifies the output part 122 about the plurality of speed limits indicated by the recognized plurality of signs.

When the identification part 121 determines that the plurality of speed limit signs are installed (YES in S13), the output part 122 determines whether the gross weight is equal to or greater than a weight threshold (S14). When it is determined that the gross weight is equal to or greater than the weight threshold (YES in S14), the output part 122 selects a first speed limit (S15). When it is determined that the gross weight is less than the weight threshold (NO in S14), the output part 122 selects a second speed limit higher than the first speed limit (S16).

Next, the output part 122 causes the display 2 to display the selected speed limit as an applied speed limit (S17). When the identification part 121 determines that the plurality of speed limit signs are not installed (NO in S13), the output part 122 causes the display 2 to display the speed limit notified from the identification part 121 as the applied speed limit.

The CPU 12 monitors whether an instruction to stop power supply of the vehicle V (ignition off) is input (S18), and repeats the processing from S12 to S17 if the instruction to stop the power supply is not input (NO in S18). When the instruction to stop the power supply is input (YES in S18), the CPU 12 ends the process of displaying the applied speed limit on the display 2.

### Variation Example 1

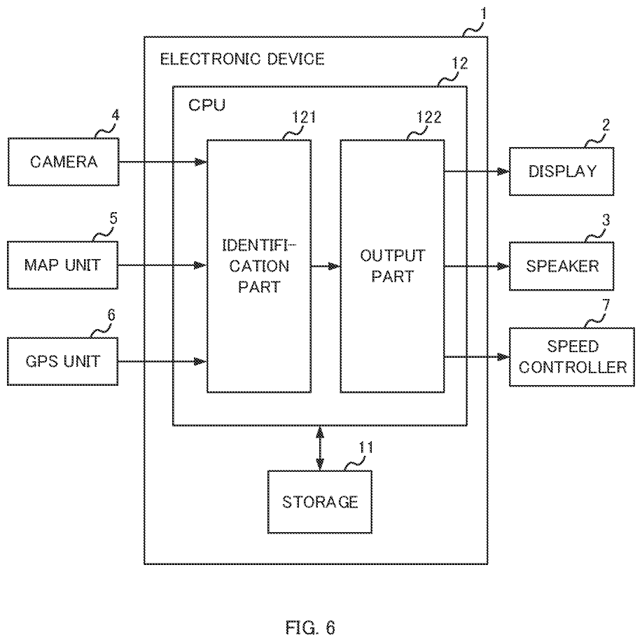

FIG. 6 shows a configuration of a vehicle V according to Variation Example 1. The vehicle V shown in FIG. 6 further includes a speed controller 7, and is different from the vehicle V shown in FIG. 3 in a point that the output part 122 outputs information indicating a speed limit to the speed controller 7, and is the same with respect to the other points.

The speed controller 7 controls a traveling speed of the vehicle V by controlling an engine or a motor. The speed controller 7 controls the speed of the vehicle V so as not to exceed the speed limit corresponding to the information input from the output part 122.

When the output part 122 receives approval from a driver of the vehicle V after displaying the applied speed limit on the display 2, the output part 122 notifies the speed controller 7 to control the speed of the vehicle V on the basis of the applied speed limit. Since the output part 122 operates in this manner, it is possible to prevent the speed controller 7 from causing the vehicle V to travel at a speed against the driver's will.

### Variation Example 2

In the above description, cases where the identification part 121 identifies the speed limit on the basis of the captured image data are exemplified, but the present embodiment is not limited thereto. The identification part 121 may identify at least one of a plurality of map speed limits indicated by map data of a road on which the vehicle V is traveling or a plurality of actual speed limits indicated by a plurality of speed limit signs recognized on the basis of captured image data generated while the vehicle V is traveling, as the plurality of speed limits.

The identification part 121 identifies a speed limit corresponding to the code information associated with a position of the vehicle V in the map data as the map speed limit by referencing the speed limit data table shown in FIG. 4. When a plurality of pieces of code information are associated with the position of the vehicle V, the identification part 121 identifies a plurality of speed limits corresponding to the plurality of pieces of code information as a plurality of map speed limits.

The output part 122 selects one of the plurality of map speed limits on the basis of the class of the vehicle V (for example, gross weight). A process of selecting one map speed limit performed by the output part 122 is the same as a process of selecting one speed limit (that is, actual speed limit) on the basis of the captured image data.

When the identification part 121 cannot identify the plurality of actual speed limits, the output part 122 outputs one map speed limit selected from among the plurality of map speed limits as the applied speed limit. Since the output part 122 operates in this manner, the display 2 can display the speed limit even when the camera 4 cannot generate captured image data.

When the identification part 121 identifies the plurality of actual speed limits, the output part 122 may output one actual speed limit selected from among the plurality of actual speed limits as the applied speed limit, instead of the map speed limit. Since the output part 122 operates in this manner, the display 2 can display the correct speed limit when the speed limit is temporarily set lower due to the influence of weather, construction work, or the like.

When the applied speed limit based on the plurality of map speed limits and the applied speed limit based on the plurality of actual speed limits match with each other, the output part 122 outputs the matched speed limit as the applied speed limit. When the applied speed limit based on the plurality of map speed limits does not match the applied speed limit based on the plurality of actual speed limits, the output part 122 outputs an applied speed limit that is the lower of (i) the applied speed limit based on the plurality of map speed limits and (ii) the applied speed limit based on the plurality of actual speed limits. Since the output part 122 operates in this manner, it is possible to prevent the driver or the speed controller 7 from erroneously recognizing a speed limit that exceeds the actual speed limit.

### Variation Example 3

In the above description, the output part 122 selects one speed limit from the plurality of speed limits by comparing the gross weight of the vehicle V to the weight threshold, but the output part 122 may select one speed limit using other factors corresponding to the classes of the vehicles V. For example, the output part 122 may output the first speed limit among the plurality of speed limits as the applied speed limit when the passenger capacity stored in the storage 11 is equal to or greater than a capacity threshold, and may output the second speed limit that is higher than the first speed limit among the plurality of speed limits as the applied speed limit when the passenger capacity is not equal to or greater than the capacity threshold. [Effect of the electronic device 1]

As described above, the output part 122 of the electronic device 1 according to the present embodiment outputs the first speed limit among the plurality of speed limits identified by the identification part 121 as the applied speed limit when the gross weight or the passenger capacity stored in the storage 11 is equal to or greater than the threshold. On the other hand, when the gross weight or the passenger capacity is not equal to or greater than the threshold, the output part 122 outputs the second speed limit that is higher than the first speed limit among the plurality of speed limits as the applied speed limit. Since the electronic device 1 is configured in this manner, even when the characters of the auxiliary sign cannot be correctly recognized, the speed limit corresponding to the vehicle V can be identified, and therefore the accuracy of recognizing the speed limit of the road on which the vehicle V is traveling improves.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An electronic device comprising:
a storage that stores a gross weight of a vehicle;
an identification part that identifies a plurality of speed limits of a road on which the vehicle is traveling; and
an output part that outputs a first speed limit among the plurality of speed limits as an applied speed limit when the gross weight stored in the storage is equal to or greater than a threshold, and outputs a second speed limit that is higher than the first speed limit among the plurality of speed limits as the applied speed limit when the gross weight is not equal to or greater than the threshold.

2. The electronic device according to claim 1, wherein
the first speed limit is a lowest speed limit among the plurality of speed limits.

3. The electronic device according to claim 2, wherein
the first speed limit is the lowest speed limit among the plurality of speed limits excluding a minimum speed limit of the road on which the vehicle is traveling, if the plurality of speed limits include the minimum speed limit.

4. The electronic device according to claim 1, wherein
the second speed limit is a lowest speed limit among the plurality of speed limits.

5. The electronic device according to claim 1, wherein
the output part causes the display apparatus of the vehicle to display the applied speed limit by outputting the applied speed limit to the display apparatus of the vehicle.

6. The electronic device according to claim 1, wherein
the output part outputs the applied speed limit to a speed controller for controlling the speed of the vehicle.

7. The electronic device according to claim 6, wherein
the output part notifies the speed controller to control a speed of the vehicle on the basis of the applied speed limit when the output part receives approval from a driver of the vehicle after displaying the applied speed limit on a display apparatus of the vehicle.

8. The electronic device according to claim 1, wherein
the identification part identifies, as the plurality of speed limits, at least one of a plurality of actual speed limits indicated by a plurality of speed limit signs recognized on the basis of a plurality of map speed limits indicated by map data of a road on which the vehicle is traveling or a plurality of actual speed limits indicated by a plurality of speed limit signs recognized on the basis of captured image data generated during traveling of the vehicle.

9. The electronic device according to claim 8, wherein
the identification part identifies at least one of the plurality of actual speed limits as the plurality of speed limits without performing character recognition on an auxiliary sign that indicates a class of vehicle.

10. The electronic device according to claim 1, wherein
the identification part identifies, as the plurality of speed limits, at least one of a plurality of map speed limits indicated by map data of a road on which the vehicle is traveling or a plurality of actual speed limits indicated by a plurality of speed limit signs recognized on the basis of captured image data generated during traveling of the vehicle, and the output part outputs an applied speed limit lower of (i) the applied speed limit based on the plurality of map speed limits and (ii) the applied speed limit based on the plurality of actual speed limits.

11. The electronic device according to claim 1, wherein
the storage stores a first weight threshold and a second weight threshold smaller than the first weight threshold, and
the output part outputs
the lowest speed limit among three speed limits corresponding to three signs as the applied speed limit when the gross weight of the vehicle is equal to or greater than the first weight threshold,
the second lowest speed limit among the three speed limits as the applied speed limit when the gross weight of the vehicle is equal to or greater than the second weight threshold and less than the first weight threshold, and
the highest speed limit among the three speed limits as the applied speed limit when the gross weight of the vehicle is less than the second weight threshold.

12. An electronic device comprising:
a storage that stores a passenger capacity of a vehicle;
an identification part that identifies a plurality of speed limits on a road on which the vehicle is traveling; and
an output part that outputs a first speed limit among the plurality of speed limits as an applied speed limit when the passenger capacity stored in the storage is equal to or greater than a threshold, and outputs a second speed limit which is higher than the first speed limit among the plurality of speed limits as the applied speed limit when the passenger capacity is not equal to or greater than the threshold.

13. A vehicle including the electronic device according to claim 1.

14. A non-transitory storage medium that stores a program for causing a computer to function as:
an identification part that identifies a plurality of speed limits on a road on which the vehicle is traveling; and
an output part that outputs a first speed limit among the plurality of speed limits as an applied speed limit when a gross weight stored in a storage is equal to or greater than a threshold, and outputs a second speed limit that is higher than the first speed limit among the plurality of speed limits as the applied speed limit when the gross weight is not equal to or greater than the threshold.
